(19) United States
(12) Patent Application Publication
(10) Pub. No.: US 2008/0174806 A1
(43) Pub. Date: Jul. 24, 2008

(54) System and method for accessing electronic documents via a document processing device

(76) Inventors: Harpreet Singh, Orange, CA (US); Louis Ormond, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/626,798

(22) Filed: Jan. 24, 2007

(51) Int. Cl. G06F 3/12; G06F 17/30; G06F 3/00

(52) U.S. Cl. 358/1.15; 707/1; 715/700

(57) ABSTRACT

The subject application is directed to a document processing device control and file navigation system and method. Identification data is received from a user via a user interface associated with a document processing device. Control image data is then displayed to the user representing control operations of the device, from which the user then selects either a document processing operation or a file operation via the user interface. When a document processing operation is selected, control input data is received from the user representing a desired device operation. When a file operation is selected, electronic files and storage areas associated with the user are retrieved and displayed. File operation data is then received via the interface, corresponding to the selection of an electronic document file operation. The received file operation data is then communicated via a computer network to a data processing device for the commencement of the selected operation.

### BACKGROUND OF THE INVENTION

The subject application is directed to a system and method for accessing electronic documents via a document processing device. In particular, the subject application is directed to a system and method for accessing electronic documents stored on a document management system directly via a document processing device.

A user of a document processing device, such as a multifunctional peripheral device, will use such device to perform a selected document processing job on an electronic document. Often such electronic documents are stored on an associated document management system. In order to perform such job, the user will have to access such document via a networked workstation or other similar device in data communication with the document processing device. The electronic document as well as the request for the document processing job will then be transmitted to the document processing device. In current document processing devices, the user is not able to access an electronic document stored on an associated document management system directly from the document processing device. Therefore, if the user does not have access to a workstation or other similar device, the user will not be able to request the desired document processing operation.

In addition, once the user has requested a document processing operation via workstation, the user is not able to modify the document processing job via the document processing device. In the event the user is waiting on the job at the document processing device and desires a modification or additional processing, the user must access a workstation rather than input such changes via the document processing device. It would be desirable to have a system and method for accessing electronic documents stored on a document management system directly via a document processing device.

The subject application overcomes the above-noted limitations and provides a system and method for accessing electronic documents via a document processing device.

### SUMMARY OF THE INVENTION

In accordance with the subject application, there is provided a system and method for accessing electronic documents via a document processing device.

Further, in accordance with the subject application, there is provided a system and method for accessing electronic documents stored on a document management system directly via a document processing device.

Still further, in accordance with the subject application, there is provided a document processing device control and file navigation system which includes a user interface including a display and a user input device. The system also comprises means adapted for receiving identification data from an associated user via the user interface and means adapted for generating control image data on the display representative of control operations for an associated document processing device. The system further includes means adapted for receiving selection data from the associated user via the user interface, the selection data selecting at least one of document processing device control and electronic document file operations and means adapted for receiving, upon selection of document processing device control, control input data from an associated user representative of at least one desired operation of the document processing device selected in accordance with a display of control image data on the display. The system also comprises means adapted for retrieving, via an associated network, electronic file data representative of electronic files and storage areas associated with received identification data. In addition, the system includes means adapted for generating, upon selection of electronic document file operations, file image data on the display corresponding to retrieved electronic file data, means adapted for receiving file operation data from the associated user via the user interface, wherein the file operation data is representative of at least one selected file operation selected in accordance with a display of file image data on the display, and means adapted for communicating received file operation data via the associated network to a networked data processing device for commencement of a file operation corresponding thereto.

In one embodiment, the at least one selected file operation is selected from a group including file listing, document preview, file folder navigation, file modification, file relocation, file deletion, file folder creation, file folder deletion, and file copy.

In another embodiment, the user interface is comprised of a touch sensitive screen.

In a further embodiment, the document processing device includes a scanner, and wherein the selected file operation includes data representative of a routing from a scan operation to a selected file location selected in accordance with a display of file image data on the display. Preferably, such embodiment further comprises means adapted for communicating scan data resultant from a scan operation of the scanner to the selected file location via the associated network. Preferably, the selected file location is selected from the set comprising web publication, printer output, a destination profile, and file storage location.

Still further, in accordance with the subject application, there is provided document processing device control and file navigation method in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the document processing device control and file navigation system according to the subject application;

FIG. 2 is a block diagram illustrating controller hardware for use in the document processing device control and file navigation system according to the subject application;

FIG. 3 is a functional diagram illustrating the controller for use in the document processing device control and file navigation system according to the subject application;

FIG. 4 is a block diagram illustrating device hardware for use in the document processing device control and file navigation system according to the subject application;

FIG. 5 is a functional diagram illustrating the device for use in the document processing device control and file navigation system according to the subject application;

FIG. 6 is a block diagram illustrating a server for use in the document processing device control and file navigation system according to the subject application;

FIG. 7 is a flowchart illustrating a document processing device control and file navigation method according to the subject application;

FIG. 8 is a flowchart illustrating a document processing device control and file navigation method from a device point of view according to the subject application;

FIG. 9 is a flowchart illustrating a document processing device control and file navigation method from a server point of view according to the subject application;

FIG. 10 is a template illustrating a graphical user interface screen for use in the document processing device control and file navigation system according to the subject application;

FIG. 11 is a template illustrating a graphical user interface screen for use in the document processing device control and file navigation system according to the subject application;

FIG. 12 is a template illustrating a graphical user interface screen for use in the document processing device control and file navigation system according to the subject application; and

FIG. 13 is a template illustrating a graphical user interface screen for use in the document processing device control and file navigation system according to the subject application.

### DETAILED DESCRIPTION OF THE PREFERRED EMBODIMENT

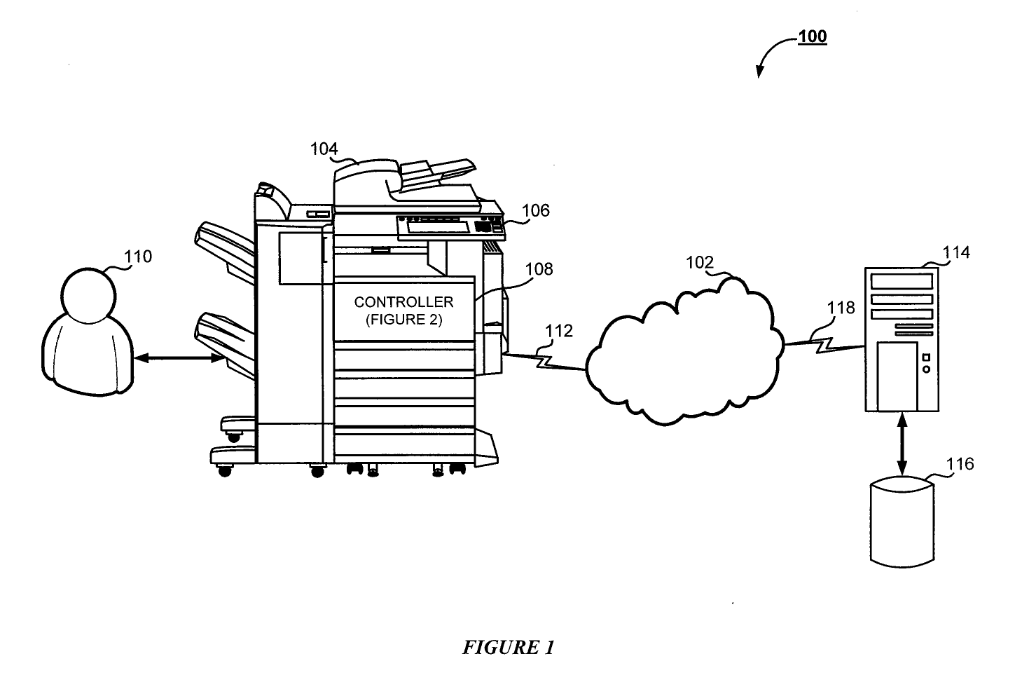

The subject application is directed to a system and method for accessing electronic documents via a document processing device. In particular, the subject application is directed to a system and method for accessing electronic documents stored on a document management system directly via a document processing device. More particularly, the subject application is directed to a document processing device control and file navigation system and method. It will become apparent to those skilled in the art that the system and method described herein are suitably adapted to a plurality of varying electronic fields employing user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for document processing device control and file navigation in accordance with the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to perform requested document processing operations, as well as retrieval, editing, display, and transmission of electronic files. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

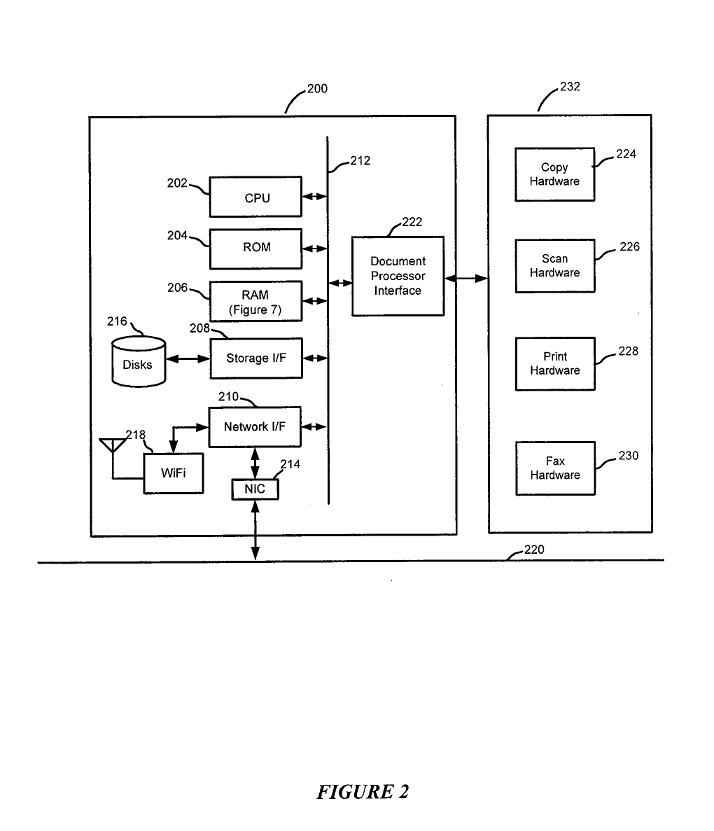

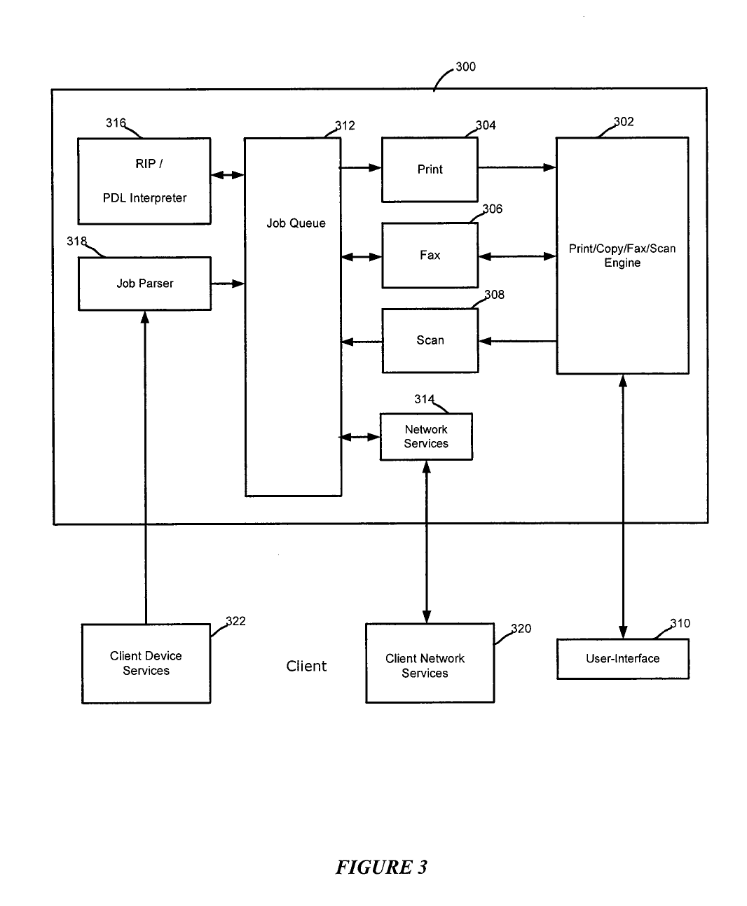

In accordance with the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for previewing document processing media of the subject application. The functioning of the controller 108 will better be understood in conjunction with the block diagrams illustrated in FIGS. 2 and 3, explained in greater detail below.

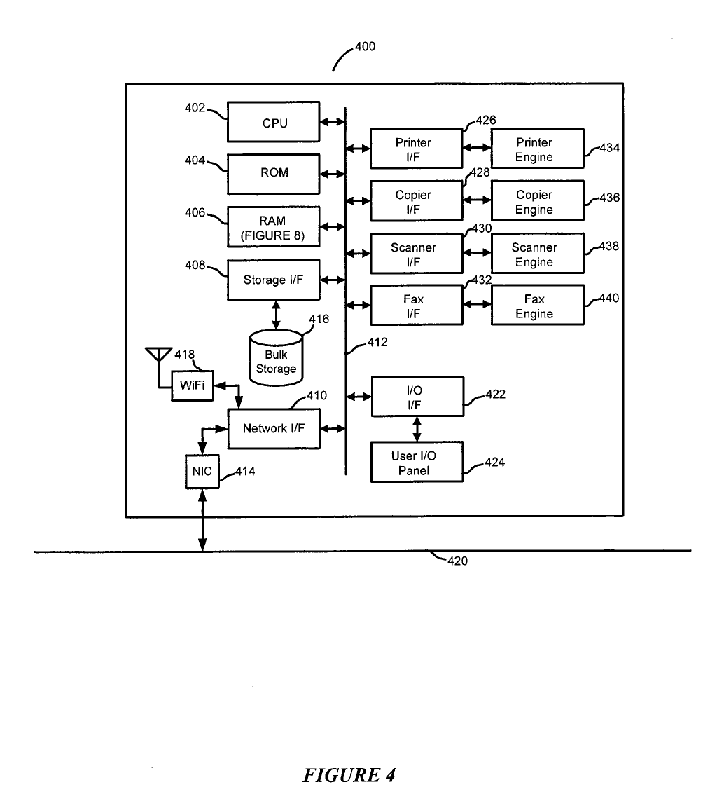

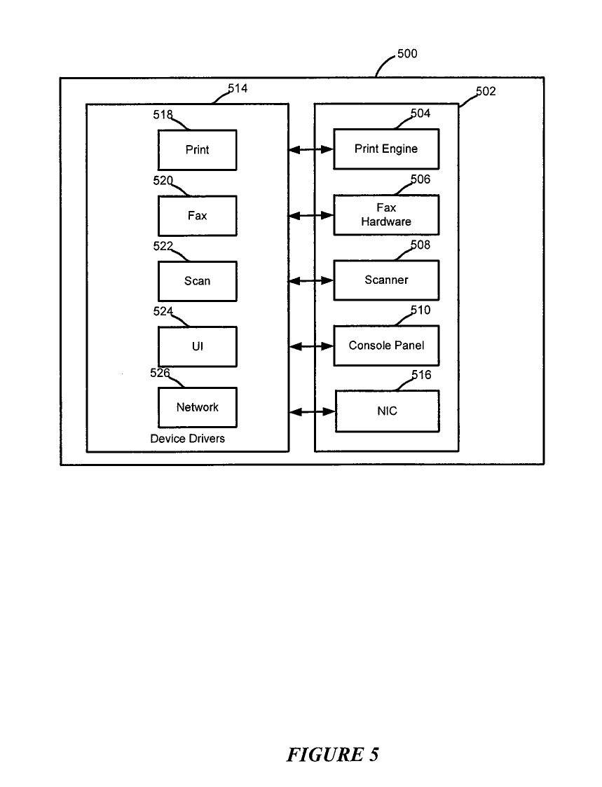

In accordance with the preferred embodiment of the subject application, the document processing device 104 is representative of a plurality of such document processing devices constituting a distributed document processing system. Preferably, this document processing system enables users to request document processing operations from any one or more of the document processing devices connected thereto, retrieve and store electronic documents via any one of such document processing devices, and the like. According to one aspect of the subject application, an associated user is able to log into the distributed document processing system via any one or more of the associated document processing devices and request the performance of a document processing operation, the retrieval of a document from a network storage location, the transmission of an electronic document via electronic mail, or the like. The skilled artisan will appreciate that such a system is capable of performing such document processing services based upon payment of costs associated therewith. In accordance with one aspect of the subject application, each document processing device of the distributed document processing system is located in different geographical locations, thereby enabling a user to access the system from a plurality of different locations. The functioning of the document processing device 104 will be more fully explained below with respect to FIG. 4 and FIG. 5.

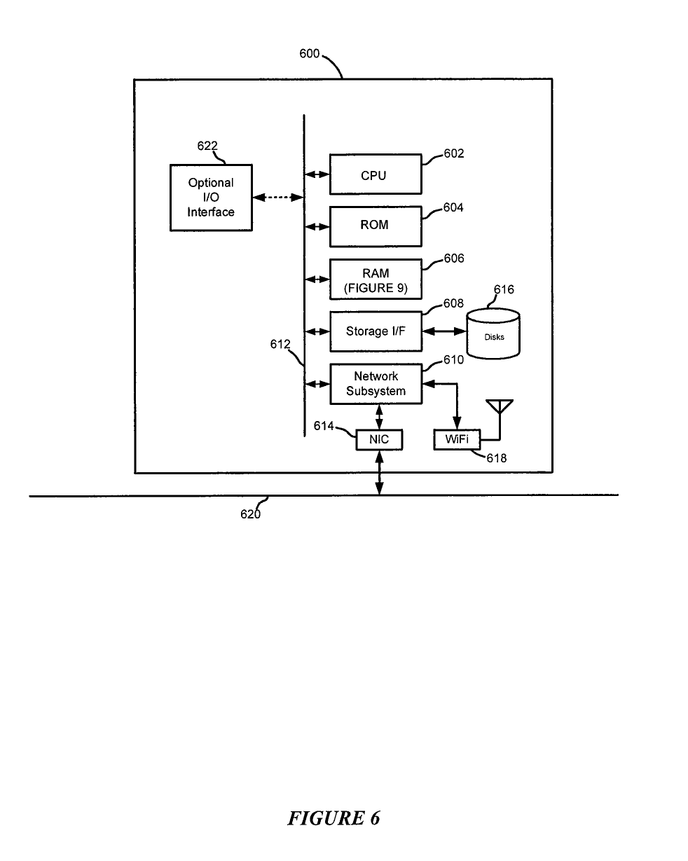

The system 100 illustrated in FIG. 1 further includes a document management component, shown as a document management server 114, communicatively coupled to the computer network 102 and adapted to provide document storage functions to users associated with the distributed document processing system. The document management server 114 is capable of implementation as any hardware, software, or suitable combination thereof, able to perform the functions described hereinafter. Preferably, the document management server 114 is communicatively coupled to the computer network 102 via a suitable communications link 118. As will be understood by those skilled in the art, the communications link 118 is suitably adapted to provide secure data communications between the document management server 114, the document processing device 104, or other devices associated with the distributed document processing system. The functioning of the document management server 114 is more fully explained in detail below with respect to FIG. 6.

Communicatively coupled to document management server 114 is a data storage device 116, representative of a document storage repository, an electronic mailbox, or the like. In accordance with the preferred embodiment of the subject application, the data storage device 116 is any mass storage device known in the art including, for example and without limitation, magnetic storage drives, a hard disk drive, optical storage devices, flash memory devices, or any suitable combination thereof. In the preferred embodiment, the data storage device 116 is suitably adapted to store document data, image data, electronic database data, or the like. Preferably, the document repository on the data storage device 116 is capable of storing documents in a hierarchical folder structure in association with a given user. It will be appreciated by those skilled in the art that while illustrated in FIG. 1 as being a separate component of the system 100, the data storage device 116 is capable of being implemented as internal storage component of the document management server 114, or the like, such as, for example and without limitation, an internal hard disk drive, or the like.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. Document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device 104 that includes the controller 200 of FIG. 2, (shown in FIG. 1 as the controller 108), as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with print function 304, facsimile function 306, and scan function 308. These devices facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with the client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, illustrated is a representative architecture of a suitable device 400 on which operations of the subject system 100 are completed. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the server 400.

Also included in the server 400 is random access memory 406, suitably formed of dynamic random access memory, static random access memory, or any other suitable, addressable memory system. Random access memory provides a storage area for data instructions associated with applications and data handling accomplished by processor 402.

A storage interface 408 suitably provides a mechanism for volatile, bulk or long term storage of data associated with the device 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the device 400 to communicate to other devices. Network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 414 is interconnected for data interchange via a physical network 420, suitably comprised of a local area network, wide area network, or a combination thereof.

Data communication between the processor 402, read only memory 404, random access memory 406, storage interface 408 and network subsystem 410 is suitably accomplished via a bus data transfer mechanism, such as illustrated by the bus 412.

Suitable executable instructions on the device 400 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 422 to a user input/output panel 424 as will be appreciated by one of ordinary skill in the art.

Also in data communication with the bus 412 are interfaces to one or more document processing engines. In the illustrated embodiment, printer interface 426, copier interface 428, scanner interface 430, and facsimile interface 432 facilitate communication with printer engine 434, copier engine 436, scanner engine 438, and facsimile engine 440, respectively. It is to be appreciated that the device 400 suitably accomplishes one or more document processing functions. Systems accomplishing more than one document processing operation are commonly referred to as multifunction peripherals or multifunction devices.

Turning now to FIG. 5, illustrated is a suitable document processing device for use in connection with the disclosed system. FIG. 5 illustrates suitable functionality of the hardware of FIG. 4 in connection with software and operating system functionality as will be appreciated by one of ordinary skill in the art. The document processing device 500 suitably includes an engine 502 which facilitates one or more document processing operations.

The document processing engine 502 suitably includes a print engine 504, facsimile engine 506, scanner engine 508 and console panel 510. The print engine 504 allows for output of physical documents representative of an electronic document communicated to the processing device 500. The facsimile engine 506 suitably communicates to or from external facsimile devices via a device, such as a fax modem.

The scanner 508 suitably functions to receive hard copy documents and in turn image data corresponding thereto. A suitable user interface, such as the console panel 510, suitably allows for input of instructions and display of information to an associated user. It will be appreciated that the scanner 508 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 5, the document processing engine 502 also comprises an interface 516 with a network via driver 526, suitably comprised of a network interface card. It will be appreciated that a network thoroughly accomplishes that interchange via any suitable physical and non-physical layer, such as wired, wireless, or optical data communication.

The document processing engine 502 is suitably in data communication with one or more device drivers 514, which device drivers allow for data interchange from the document processing engine 502 to one or more physical devices to accomplish the actual document processing operations. Such document processing operations include one or more of printing via driver 518, facsimile communication via driver 520, scanning via driver 522 and a user interface functions via driver 524. It will be appreciated that these various devices are integrated with one or more corresponding engines associated with the document processing engine 502. It is to be appreciated that any set or subset of document processing operations are contemplated herein. Document processors which include a plurality of available document processing options are referred to as multi-function peripherals.

Turning now to FIG. 6, illustrated is a representative architecture of a suitable server 600 (shown in FIG. 1 as the document management server 114) on which operations of the subject system 100 are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. Network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

In operation, user identification data is first received from an associated user via an associated user interface. Control image data is then generated on a display of the user interface. The control image data preferably represents control operations for an associated document processing device. Selection data is then received from the associated user via the user interface. The selection data corresponds to the selection by the user of a document processing device control or an electronic document file operation. When a document processing device control is selected, as determined from the selection data, control input data is received from the user via the user interface. The control input data corresponds to a desired operation of the document processing device, which was selected in accordance with the display of the control image data on the display. When an electronic file operation is selected by the user, electronic file data and storage areas associated with the user identification data are retrieved. File image data is then generated on the display of the associated user interface following selection of electronic document file operations by the user. File operation data is then received from the associated user via the user interface, corresponding to the selection of an electronic document file operations by the user from among the file image data displayed. The received file operation data is then communicated via a computer network to a data processing device for the commencement of the selected file operation.

In accordance with one example embodiment of the subject application, an associated user accesses the system 100 via the user interface 106 of the document processing device 104 by submitting user identification data. Suitable identification data includes, for example and without limitation, a username and/or password, an alphanumeric sequence of characters, biometric data, or the like. Preferably, the user submits the identification data via a touch screen implementation of the user interface 106, as will be appreciated by those skilled in the art. The controller 108, or other suitable component of the document processing device 104, then directs the prompting of the user via a display associated with the user interface 106, to select an operation capable of being initiated by the document processing device 104. Such operations include, for example and without limitation, local document processing operations, such as scan, copy, print, facsimile, scan-to-email, scan-to-storage (local device 104 or removable media), or the like, as well as file operations such as, file listing, document preview, file folder navigation, file modification, file relocation, file deletion, file folder creation, file folder deletion, file copy, or the like.

When the selected operation is a local document processing operation, a determination is then made whether the selected local operation is a scan-to-location operation. When the operation is not a scan operation, e.g., not the generation of electronic image data to remain in electronic form, the requested document processing operation is performed by the associated document processing device 104. When the local operation is a scan-to-location operation, the user is prompted, via the associated user interface 106, to select a suitable storage location. Preferably, the document processing device 104 ascertains available storage locations via the computer network 102, e.g., the data storage device 116, other network device, etc. The skilled artisan will appreciate that the document processing device 104 is suitably capable of determining the available storage locations via communications with the document management server 114, whereupon the server 114 returns storage location data to the document processing device 104 for user selection thereof. That is, the user specifies the routing from the scan operation to the selected file location via the touch screen of the user interface 106. Suitable file locations include, for example and without limitation, a web publication, a printer output, a destination profile, a file storage location, or the like. Once the storage location has been selected by the user, the document processing device 104 generates electronic image data corresponding to the document being scanned. The image data is then transmitted, via the computer network 102, to the designated storage location, e.g., the data storage device 116. Preferably, the image data is transmitted in association with the user identification data, resulting in the association of the user identification data with the newly generated image data on the data storage device 116.

When the selected operation is not a local operation, i.e., it is an electronic document file operation, the electronic files and storage areas associated with the user identification data are retrieved from the document management server 114 via the computer network 102. As will be appreciated by those skilled in the art, the electronic files and storage areas are capable of being located on any device communicatively coupled to the document management system accessible via the computer network 102, including, for example and without limitation, the document processing device 104, the data storage device 116, another document processing device (not shown), or other networked data processing or storage device, as are known in the art. Suitable electronic document file operations include, for example and without limitation, file folder navigation, file folder creation, file folder deletion, file listing, file modification, file relocation, file deletion, file copy, and the like. The retrieved electronic files and storage areas are then displayed to the user via the associated user interface 106. The user is then prompted to select one or more files, as well as a corresponding file operation, via the user interface 106 of the associated document processing device 104. Once this selection is received by the document processing device 104, the file operation selected is communicated to a data processing device, e.g., the server 114, communicatively coupled to the computer network 102. Preferably, the file operation communicated includes data representing the one or more selected files on which the file operation is to be performed. The data processing device then commences the requested file operation on the associated electronic document files.

In accordance with the forgoing example embodiment of the subject application, the document management server 114 receives the user identification data via the computer network 102. The server 114 then retrieves those files and storage areas corresponding to the received user identification data. It will be apparent to those skilled in the art, the server 114 is capable of surveying the computer network 102 for files and storage areas corresponding to the received user identification data, inclusive of the data storage device 116. The retrieved files and storage areas are then communicated to the requesting document processing device 104 via the computer network 102. The document management server 114 then receives selection data corresponding to a file operation and a file upon which the selected operation is to be performed. The requested file operation is then performed by the server 114 on the selected file. It will be appreciated by those skilled in the art that the server 114 suitably receives the requested file operation because the corresponding file is located in a storage area under the purview of the server 114. Thus, as will be apparent to those skilled in the art, the server 114 is capable of functioning as a data processing device, thereby enabling the file operation to be performed thereon.

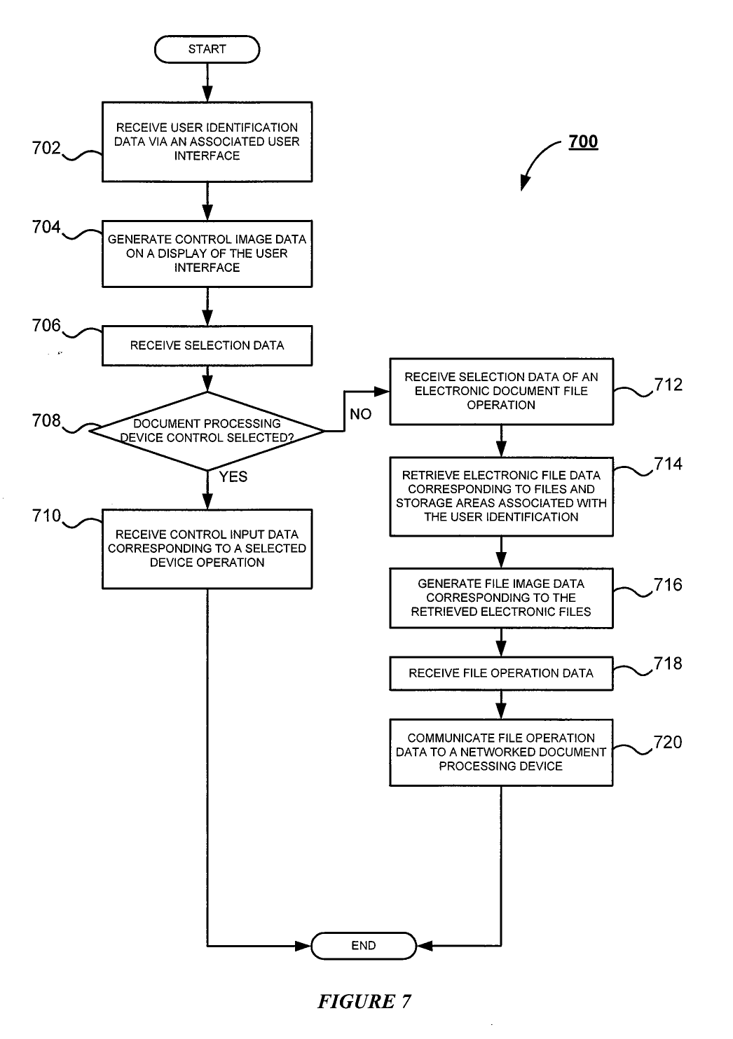

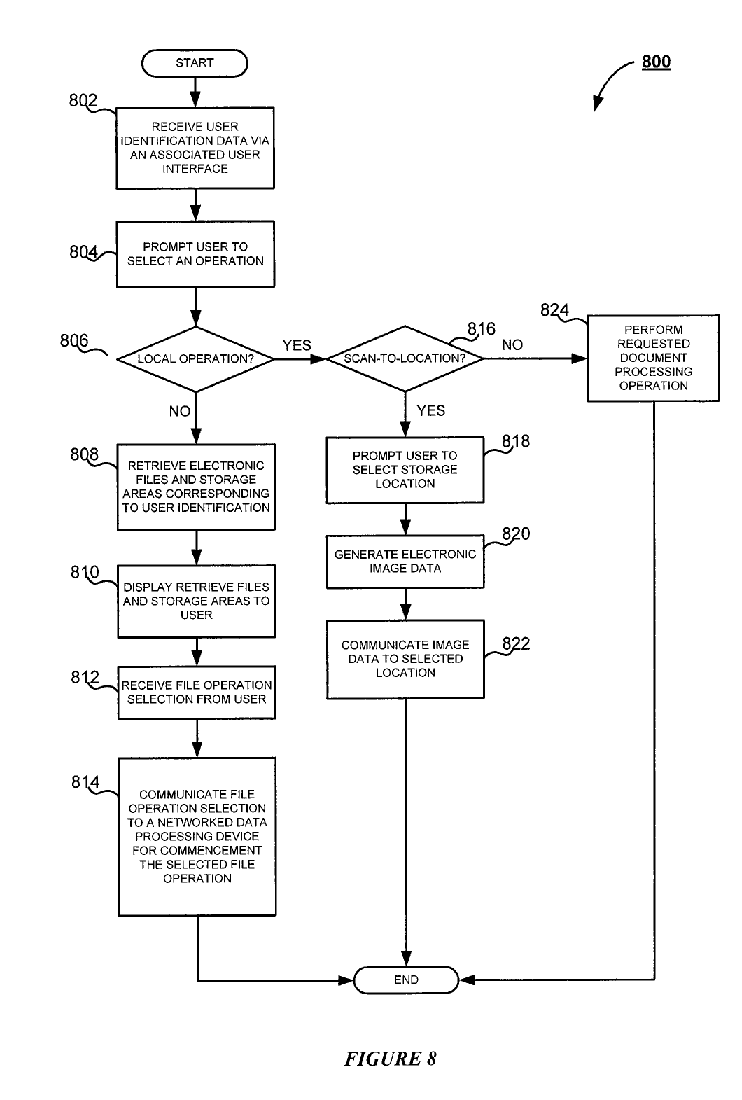

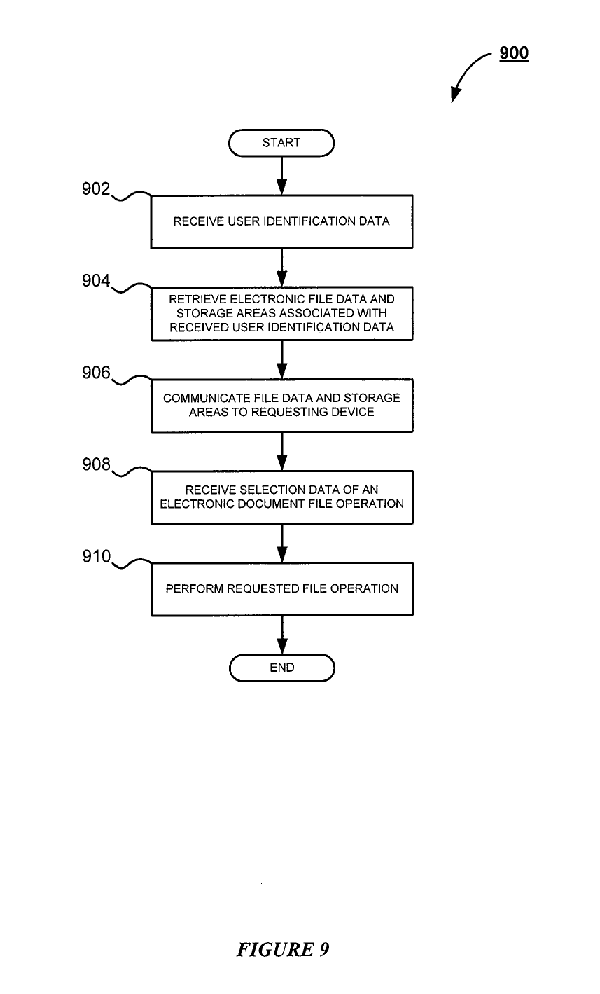

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7, FIG. 8, and FIG. 9. Turning now to FIG. 7, there is shown a flowchart 700 illustrating a document processing device control and file navigation method in accordance with the subject application. Beginning at step 702, user identification data is received from a user at the document processing device 104 via the associated user interface 106. The skilled artisan will appreciate that suitable user identification data includes, for example and without limitation, a username/password combination, alphanumeric sequence of characters, smart card, biometric data, or the like. Control image data is then generated at step 704 on the display of the user interface 106 representing control operations for the associated document processing device 104. Selection data is then received at step 706 corresponding to a user selection of a document processing device control or an electronic document file operation, as input by the user via the user interface 106.

A determination is then made at step 708 whether the user has selected a document processing control. When the user selects a document processing control at step 706, flow proceeds to step 710, whereupon control input data is received from the user via the associated user interface 106. The control input data preferably includes, for example and without limitation, a desired operation of the document processing device 104, or the like. Preferably, upon receipt of the control input data, the document processing device 104 commences the requested document processing operation whereupon the methodology of FIG. 7 terminates.

Upon a determination at step 708 that a document processing device control has not been selected, as determined from the received selection data, flow progresses to step 712, whereupon selection data of an electronic document file operation is received by the document processing device 104 from the user via the associated user interface 106. Suitable electronic document file operations include, for example and without limitation, document preview, file creation, file deletion, file relocation, file renaming, file copying, file modification, file listing, file folder creation, file folder deletion, file folder renaming, file folder navigation, and the like. At step 714, electronic file data and storage areas corresponding to the received user identification data are retrieved. Preferably, the document processing device 104 receives electronic file data and associated storage areas from the document management server 114 via the computer network 102. It will be appreciated by those skilled in the art that such file data and storage areas are capable of including the data storage device 116, other document processing devices (not shown) coupled to the document management system, network storage devices (not shown), network data processing devices (not shown), or the like.

Following receipt of the electronic file data and storage areas at step 714, flow proceeds to step 716, whereupon file image data corresponding to the retrieved file data and storage areas is generated via the associated user interface 106. Preferably, the display associated with the user interface 106 illustrates graphical, textual, or a suitable combination thereof, of the retrieved data, such as in the form of documents, directories, folders, and the like. File operation data is then received at step 718 corresponding to a selected file operation from the user via the associated user interface 106. For example, the user selects a folder or document along with a desired operation to be performed thereon via the user interface 106. The skilled artisan will appreciate that a touch screen interface is capable of being employed herein to facilitate user selection and interaction. The file operation data, corresponding to the requested file operation and any document, folder or directory associated therewith, is then communicated via the computer network 102 to a suitable data processing device at step 720. The skilled artisan will appreciate that suitable data processing devices include, for example and without limitation, a document processing device 104, the document management server 114, a personal computing device in data communication with the computer network 102, or other electronic device coupled to the computer network 102 and capable of performing corresponding data processing.

Referring now to FIG. 8, there is shown a flowchart 800 illustrating a document processing device control and file navigation method from a device point of view in accordance with the subject application. From the document processing device 104 point of view, the method begins at step 802 with the receipt of user identification data from an associated user via the user interface 106 associated with the document processing device 104. The user identification is capable of including, for example and without limitation, a username and/or password, an alphanumeric account number, a smart card, biometric data, or the like. Preferably, the user interface 106 includes a touch screen display, suitably adapted to receive user inputs, display prompts, and communicate data to the user. Following suitable verification and authentication, the user is prompted at step 804 to select an operation, i.e., a local operation or an electronic document file operation via the display associated with the user interface 106. Following user selection of a desired operation, flow proceeds to step 806, whereupon a determination is made whether the user has selected a local document processing operation. The skilled artisan will appreciate that a local operation, as used herein with respect to FIG. 8, corresponds to a document processing operation capable of being performed by the document processing device 104, which does not correspond to a file operation, as explained in greater detail below. Suitable examples of a local operation include, for example and without limitation, a print operation, a scanning operation, a facsimile operation, a copying operation, and the like.

When the user has not selected a local operation, flow proceeds from step 806 to step 808, whereupon electronic files and storage areas corresponding to the received user identification data is retrieved by the document processing device 104. Preferably, this retrieval is accomplished via communications with the document management server 114 via the computer network 102. The retrieved files and storage areas, such as folders, directories, and the like, are then displayed at step 810 to the user via the display associated with the user interface 106. At step 812, a file operation selection is received from the user, as input by the user via the user interface 106. The file operation selection made by the user is then communicated to a networked data processing device, e.g., the server 114, for commencement of the selected file operation at step 814. For example, the user is able to rename a file stored in the data storage device 116 by communicating the requested file rename to the server 114 for implementation of the name change.

Returning to step 806, when the user has selected a local operation, flow proceeds to step 816, whereupon a determination is made whether the user has selected a scan-to-storage operation. That is, a determination is made whether the user has selected a scan operation with the resultant electronic image data to be stored at a specified location. When the local operation is not such a scan-to-storage operation, flow proceeds to step 824, whereupon the requested document processing operation is performed.

When the local operation selected by the user is a scan-to-location operation, as determined at step 816, flow proceeds to step 818, whereupon the user is prompted to select a desired storage location. Preferably, the user is presented, via the display of the associated user interface 106, various icons, graphics and/or text, indicating those storage areas on the computer network 102 in which the user is able to store electronic files. That is, the user specifies the routing from the scan operation to the selected file location via the user interface 106. Suitable file locations include, for example and without limitation, a web publication, a printer output, a destination profile, a file storage location, or the like. Once the user has selected the desired storage area, the document processing device 104 generates, at step 820, electronic image data representative of the hardcopy document being scanned. The image data, along with suitable identification data, is then communicated by the document processing device 104 over the computer network 102 to the designated storage area at step 822, whereupon the operation terminates.

Referring now to FIG. 9, there is shown a flowchart 900 illustrating a document processing device control and file navigation method from a server point of view in accordance with the subject application. Beginning at step 902, the document management server 114 receives user identification data via the computer network 102 corresponding to a user at an associated document processing device 104. The identification data suitably comprises, for example and without limitation, a username and/or password, alphanumeric sequence, biometric data, or the like via which the server 114 is able to ascertain the identity of the user. The document management server 114 then retrieves, at step 904, electronic file data and storage areas associated with the user identification data. For example, the server 114 searches the computer network 102 for files, folders, directories, and the like, which are associated with the user, such as folders, documents, directories, or the like on the data storage device 116. The listing of such information, e.g., filenames, locations, folder names, directory names, etc., are then communicated to the requesting document processing device 104 at step 906. The server 114 then receives selection data from the document processing device 104 at step 908 corresponding to a requested electronic document file operation. Such file operations include, for example and without limitation, file listing, document preview, file rename, file modification, file creation, file deletion, file relocation, folder creation, folder deletion, folder rename, folder relocation, and the like. At step 910, the document management server 114 suitably performs the requested file operation.

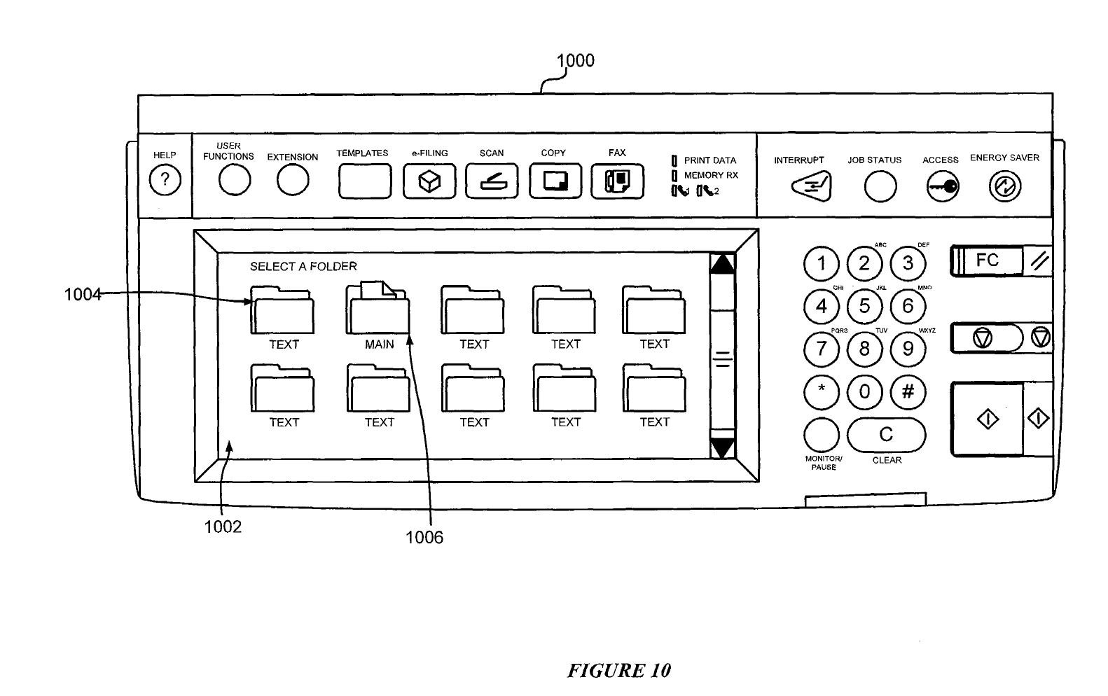

Turning now to FIGS. 10, 11, and 12, there are shown examples of a user interface implementations in accordance with the subject application, whereupon an associated user is accessing files and storage areas associated with the user to modify a document directly from the user interface 106 of the document processing device 104. With respect to FIG. 10, there is depicted a template graphical user interface for use in the document processing device control and file navigation system in accordance with the subject application. As shown in FIG. 10, the user interface 1000 includes a touch screen display 1002 illustrating various folders accessible by an associated user via the user interface 106 of the document processing device 104. The skilled artisan will appreciate that the user interface 1000 is representative of the user interface 106 associated with the document processing device 104 in accordance with the subject application. Illustrated in the touch screen display 1002 is a plurality of folders 1004 representative of storage areas on the computer network 102, inclusive of the data storage device 116, to which an associated user has access. The touch screen display 1002 further includes a main folder 1006, representative of a folder containing electronic files associated with the user. The skilled artisan will appreciate that the user interface 1000 is suitably adapted to receive user input regarding a plurality of selections, including the selection, for example, of the main folder 1006.

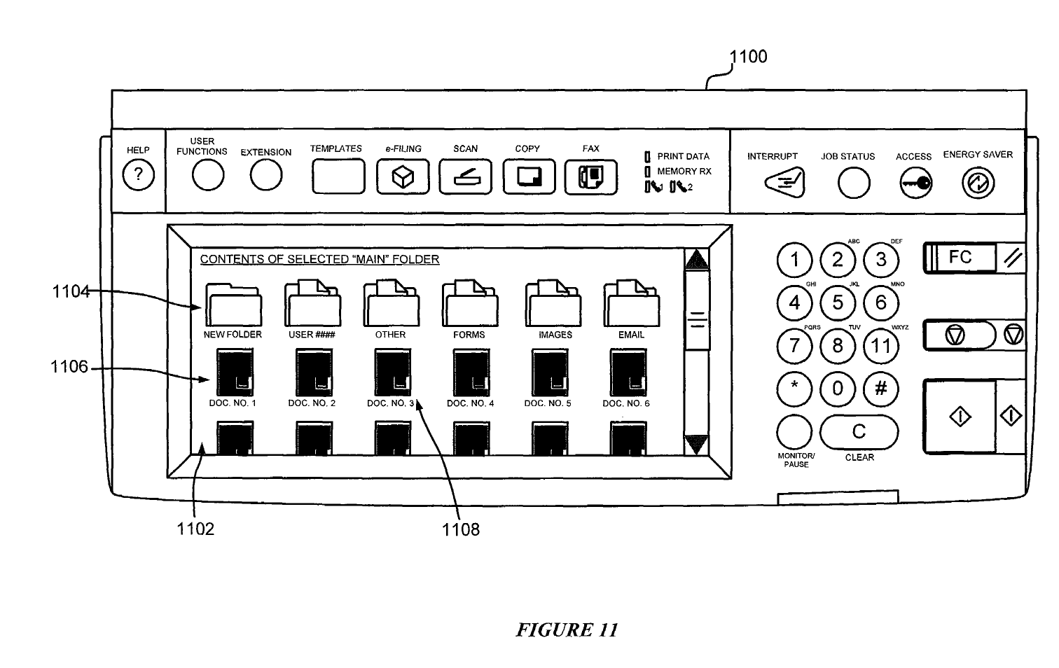

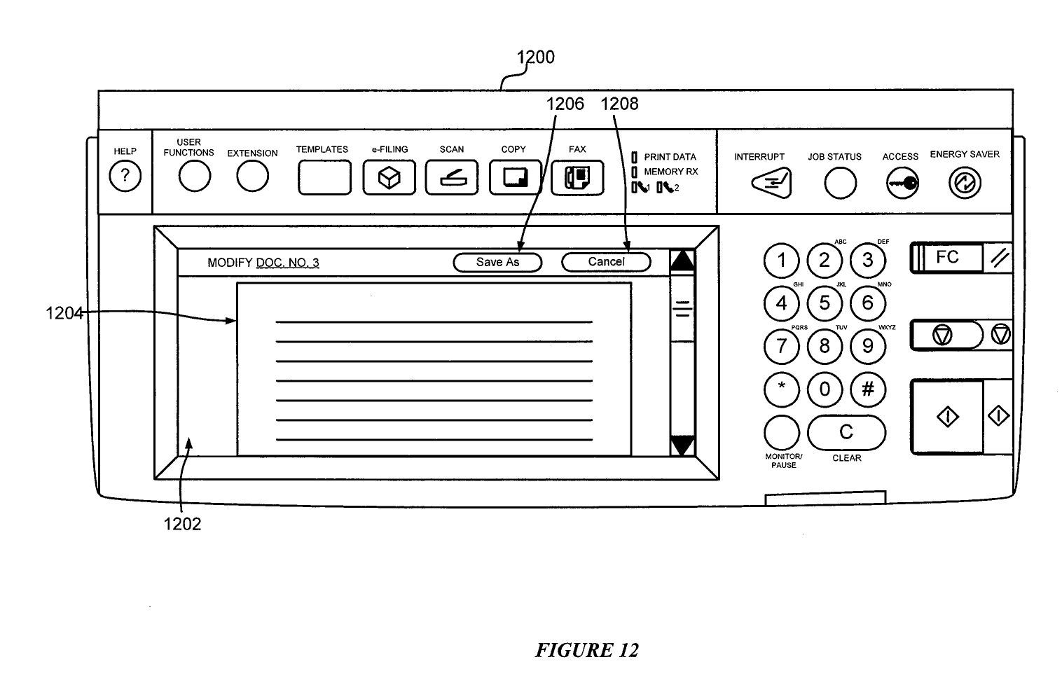

Referring now to FIG. 11, there is shown a template graphical user interface screen for use in the document processing device control and file navigation system in accordance with the subject application. FIG. 11 illustrates a user interface 1100 comprising a touch screen display 1102 of the contents of the main folder 1006 selected from FIG. 10. Thus, the skilled artisan will appreciate that upon user selection of the main folder 1006 in FIG. 10, display of the user interface 106 translates to the user interface 1100 of FIG. 11. As shown in FIG. 11, the contents of the main folder 1006 includes a plurality of subfolders 1104 and a plurality of electronic files 1106. The electronic file “Doc. No. 3” 1108 is representative of a document associated with the user that is capable of modification, renaming, or the like, via the user interface 106 of the associated document processing device 104. Thus, when the user selects the icon 1108 representing Doc. No. 3, the user interface 1100 of FIG. 11 changes to that displayed in FIG. 12.

With respect to FIG. 12, there is shown a template graphical user interface screen for use in the document processing device control and file navigation system in accordance with the subject application. The user interface 1200 of FIG. 12 suitably illustrates one file operation capable of being performed in accordance with the subject application. As shown in FIG. 12, the user interface 1200 includes a touch screen display 1202 on which is displayed the Doc. No. 3 1204, corresponding to the document 1108 of FIG. 11. Thus, as will be apparent to those skilled in the art, the user is able to modify the document 1204 and save the changes in the original storage location, i.e., the main folder 1006, using the subject application. For example, via the touch screen display 1202 of the user interface 1200, an associated user is suitably capable of editing the text of the document, changing the document margins, altering the document layout, changing the document title, storage location, or the like. Once these changes are made, the user has the option to save the changes or cancel the changes. To save the changes, the user selects the save as icon 1206, whereupon the user is prompted to specify the storage location, the title, etc., as will be understood by those skilled in the art. To cancel any changes and return to the previous screen, i.e., the display 1102 of FIG. 11, the user selects the cancel icon 1208, whereupon the changes to the document 1204 are discarded.

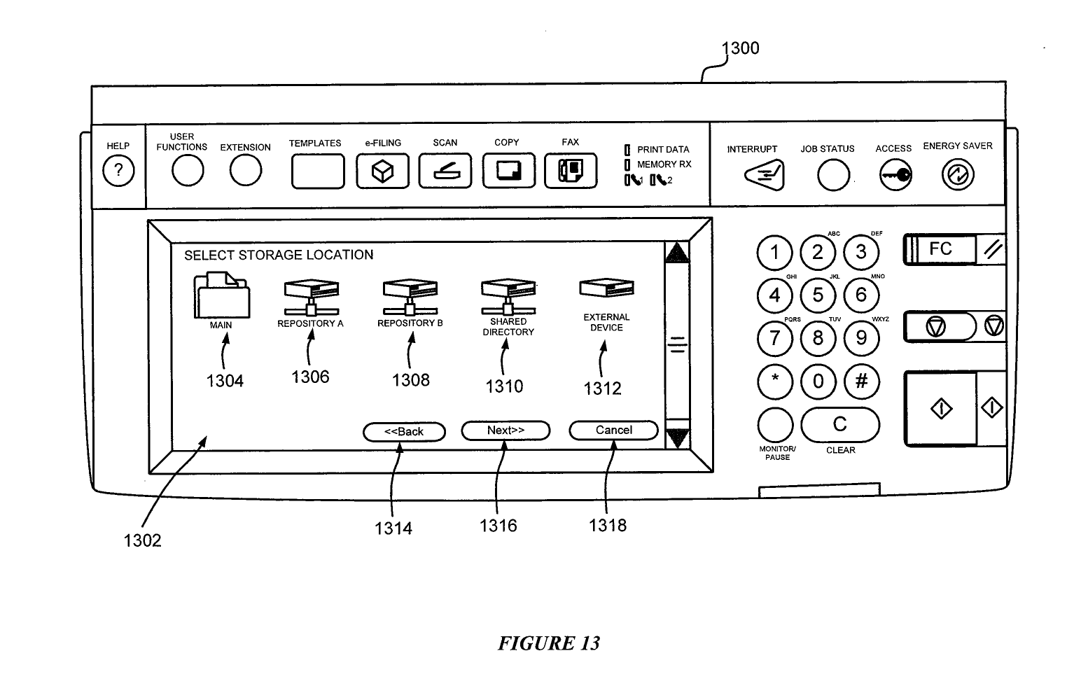

Turning now to FIG. 13, there is shown a template graphical user interface screen for use in the document processing device control and file navigation system in accordance with the subject application. The user interface 1300 of FIG. 13 illustrates an example embodiment of a scan-to-location operation in accordance with the subject application. As shown in FIG. 13, the user interface 1300 includes an associated touch screen display 1302, on which are depicted to the user various storage areas on the computer network 102 in which the image data resulting from a scanning operation is capable of being stored. The various storage areas include, for example and without limitation, a main file folder 1304, a document repository A 1306, such as that of the data storage device 116, a document repository B 1308, representative of a secondary data storage device (not shown) coupled to the computer network 102, a shared network directory 1310, and an external device 1312, such as a portable storage media coupled to the document processing device 104. Thus, the skilled artisan will appreciate that the user is presented with a variety of storage options for storing the scanned image data via the user interface 106 associated with the document processing device 104. Upon selection of a desired storage location, e.g., the main folder 1304, the user is able to select an alternate file operation, save the image data, or cancel the current file operation.

In the event that the user desires to choose a different file operation, for example, instead of scanning to storage, the user desires to transmit the image data as an attachment to an electronic mail message, the user selects the back icon 1314 on the touch screen display 1302, whereupon the user is returned to a file operation selection screen (not shown). When the user desires to complete the file operation, and has designated the corresponding storage location, the user selects the next icon 1316, whereupon the image data is transmitted to the designated storage location for storage. In the event that the user desires to cancel the scan-to-storage operation in its entirety, the user selects the cancel icon 1318. In accordance with the preferred embodiment of the subject application, upon selection of the cancel icon 1318, the user interface 106 of the document processing device 104 returns to a main screen, such as a composite local operation or file operation selection screen.

The skilled artisan will appreciate that the illustrations in FIG. 10, FIG. 11, FIG. 12, and FIG. 13 are for example purposes only. Other user interface displays are equally capable of implementation in accordance with the system and methodologies described herein. Furthermore, it will be appreciated by those skilled in the art that additional displays, in accordance with the methodologies set forth herein, are equally capable of being shown to the user to facilitate the interactions described above.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document processing device control and file navigation system comprising:
a user interface including a display and an user input device;
means adapted for receiving identification data from an associated user via the user interface;
means adapted for generating control image data on the display representative of control operations for an associated document processing device;
means adapted for receiving selection data from the associated user via the user interface, the selection data selecting at least one of document processing device control and electronic document file operations;
means adapted for receiving, upon selection of document processing device control, control input data from an associated user via the user interface representative of at least one desired operation of the document processing device selected in accordance with a display of control image data on the display;
means adapted for retrieving, via an associated network, electronic file data representative of electronic files and storage areas associated with received identification data;
means adapted for generating, upon selection of electronic document file operations, file image data on the display corresponding to retrieved electronic file data;
means adapted for receiving file operation data from the associated user via the user interface, the file operation data representative of at least one selected file operation selected in accordance with a display of file image data on the display; and
means adapted for communicating received file operation data via the associated network to a networked data processing device for commencement of a file operation corresponding thereto.

2. The document processing device control and file navigation system of claim 1 wherein the at least one selected file operation is selected from a group including file listing, document preview, file folder navigation, file modification, file relocation, file deletion, file folder creation, file folder deletion, and file copy.

3. The document processing device control and file navigation system of claim 1 wherein the document processing device includes a scanner, and wherein the selected file operation includes data representative of a routing from a scan operation to a selected file location selected in accordance with a display of file image data on the display.

4. The document processing device control and file navigation system of claim 3 further comprising means adapted for communicating scan data resultant from a scan operation of the scanner to the selected file location via the associated network.

5. The document processing device control and file navigation system of claim 3 wherein the selected file location is selected from the set comprising web publication, printer output, a destination profile, and file storage location.

6. The document processing device control and file navigation system of claim 1 wherein the user interface is comprised of a touch sensitive screen.

7. A document processing device control and file navigation method comprising the steps of:
receiving identification data from an associated user via an associated user interface;
generating control image data on a display of the user interface representative of control operations for an associated document processing device;
receiving selection data from the associated user via the user interface, the selection data selecting at least one of document processing device control and electronic document file operations;
receiving, upon selection of document processing device control, control input data from an associated user via the user interface representative of at least one desired operation of the document processing device selected in accordance with a display of control image data on the display;
retrieving, via an associated network, electronic file data representative of electronic files and storage areas associated with received identification data;
generating, upon selection of electronic document file operations, file image data on the display corresponding to retrieved electronic file data;
receiving file operation data from the associated user via the user interface, the file operation data representative of at least one selected file operation selected in accordance with a display of file image data on the display; and
communicating received file operation data via the associated network to a networked data processing device for commencement of a file operation corresponding thereto.

8. The document processing device control and file navigation method of claim 7 wherein the at least one selected file operation is selected from a group including file listing, document preview, file folder navigation, file modification, file relocation, file deletion, file folder creation, file folder deletion, and file copy.

9. The document processing device control and file navigation method of claim 7 wherein the step of selecting a file operation includes the step of selecting a routing from a scan operation to a selected file location selected in accordance with a display of file image data on the display.

10. The document processing device control and file navigation method of claim 9 further the step of communicating scan data resultant from a scan operation of the scanner to the selected file location via the associated network.

11. The document processing device control and file navigation method of claim 9 wherein the selected file location is selected from the set comprising web publication, printer output, a destination profile, and file storage location.

12. The document processing device control and file navigation method of claim 7 wherein identification data, selection data, control input data, and file operation data is received via a touch sensitive screen.

13. A computer-implemented method for document processing device control and file navigation comprising the steps of:
receiving identification data from an associated user via an associated user interface;
generating control image data on a display of the user interface representative of control operations for an associated document processing device;
receiving selection data from the associated user via the user interface, the selection data selecting at least one of document processing device control and electronic document file operations;
receiving, upon selection of document processing device control, control input data from an associated user via the user interface representative of at least one desired operation of the document processing device selected in accordance with a display of control image data on the display;
retrieving, via an associated network, electronic file data representative of electronic files and storage areas associated with received identification data;
generating, upon selection of electronic document file operations, file image data on the display corresponding to retrieved electronic file data;
receiving file operation data from the associated user via the user interface, the file operation data representative of at least one selected file operation selected in accordance with a display of file image data on the display; and
communicating received file operation data via the associated network to a networked data processing device for commencement of a file operation corresponding thereto.

14. The computer-implemented method for document processing device control and file navigation method of claim 13 wherein the at least one selected file operation is selected from a group including file listing, document preview, file folder navigation, file modification, file relocation, file deletion, file folder creation, file folder deletion, and file copy.

15. The computer-implemented method for document processing device control and file navigation of claim 13 wherein the step of selecting a file operation includes the step of selecting a routing from a scan operation to a selected file location selected in accordance with a display of file image data on the display.

16. The computer-implemented method for document processing device control and file navigation of claim 15 further comprising the step of communicating scan data resultant from a scan operation of the scanner to the selected file location via the associated network.

17. The computer-implemented method for document processing device control and file navigation of claim 15 wherein the selected file location is selected from the set comprising web publication, printer output, a destination profile, and file storage location.

18. The computer-implemented method for document processing device control and file navigation of claim 13 wherein identification data, selection data, control input data, and file operation data is received via a touch sensitive screen.
